(19) United States
(12) Patent Application Publication
(10) Pub. No.: US 2022/0064385 A1
(43) Pub. Date: Mar. 3, 2022

(54) Highly Filled Compatibilized Polymeric Concentrates

(71) Applicant: Interfacial Consultants LLC, Prescott, WI (US)

(72) Inventor: Jeffrey Jacob Cernohous, Hudson, WI (US)

(21) Appl. No.: 17/459,352

(22) Filed: Aug. 27, 2021

Related U.S. Application Data
(60) Provisional application No. 63/072,308, filed on Aug. 31, 2020.

(51) Int. Cl. C08J 3/00; C08L 101/00

(52) U.S. Cl. CPC C08J 3/005; C08L 101/00

(57) ABSTRACT

Highly filled compatibilized polymeric concentrates comprise, e.g., using one or more melt processing techniques, a functionalized liquid polymeric dispersion, including a liquid carrier and one or more polymers, and one or more fillers.

### CROSS-REFERENCE TO RELATED APPLICATION

This application claims priority to U.S. Provisional Application No. 63/072,308 filed Aug. 31, 2020, which is hereby incorporated by reference.

### TECHNICAL FIELD

This disclosure relates to highly filled compatibilized polymeric concentrate compositions and methods for producing and using the same.

### BACKGROUND

Direct processing of fillers or additives with a polymer can be difficult and dangerous for plastic manufacturers. Dispersion of the fillers or additives can be uneven, and, in their raw forms, some fillers or additives can irritate workers' skin and respiratory systems or even risk explosion. Using polymeric concentrates or masterbatches can provide an easier and safer way to process fillers and additives. Polymeric concentrates incorporate the fillers and additives into a carrier polymer, which shield workers from the mess and potential hazards of raw-form processing, and can be let down to form an end-use product or further processed.

It can, however, be difficult to produce polymeric concentrates with filler loading levels greater than about 80 weight % (wt %) or 50 volume % using conventional melt processing techniques. Around these loading levels, the viscosity of the polymeric concentrate can be too high and may ultimately torque out (viz., stall) the processing equipment. It is also difficult to maintain consistency in the let-down product when feeding fillers or additives at such loading levels, especially in low bulk density materials. Lastly, wetting of the fillers or additives may be incomplete as the loading level increases, such that the break up or clumping of fillers or additives becomes more pronounced, which can lead to poor performance in the let-down product.

### SUMMARY

There is a need for highly filled compatibilized polymeric concentrates. Highly filled compatibilized polymeric concentrates of the present disclosure comprise, e.g., using one or more melt processing techniques, a functionalized liquid polymeric dispersion, including a liquid carrier and one or more polymers, and one or more fillers. In one embodiment, one or more fillers are melt processed with a functionalized liquid polymeric dispersion. In another embodiment, the functionalized liquid polymeric dispersion is a functionalized waterborne polymeric dispersion. In yet another embodiment, the waterborne polymeric dispersion is functionalized waterborne polyolefin dispersion. In one embodiment, the filler level in the final concentrate after melt processing is greater than 80 wt% or 50 volume %. In other embodiments, the filler level in the final concentrate is greater than 90 wt% or 60 volume %. In some embodiments, other materials, e.g., additional polymers or additives, can also be included in a highly filled compatibilized polymeric concentrate.

Highly filled compatibilized polymeric concentrates can be easier and safer to handle, more cost effective, and more easily dispersed. These concentrates can also be converted into articles using compounding, extrusion, and molding techniques. These articles can have utility in a variety of markets including automotive, building and construction, and consumer and appliance industries. These concentrates can provide significant value to plastics compounders and converters.

The above summary is not intended to describe each illustrated embodiment or implementation of the subject matter hereof. The detailed description that follows more particularly exemplifies various illustrative embodiments.

### DETAILED DESCRIPTION

Unless the context indicates otherwise the following terms shall have the following meaning and shall be applicable to the singular and plural:

The terms “a,” “an,” “the,” “at least one,” and “one or more” are used interchangeably. For example, a functionalized liquid polymeric dispersion containing “a” polymer means that the functionalized liquid polymeric dispersion may include “one or more” polymers.

The term “compatibilized” means a composite where the interfacial tension between the polymeric matrix and the filler has been reduced. This can result in improved dispersion and mechanical properties.

The term “composite” refers to a multicomponent material including more than one phase domain in which at least one phase domain is a continuous phase.

The term “composition” refers to a multicomponent material.

The term “copolymer” refers to a polymer derived, actually (e.g., by copolymerization) or conceptually, from more than one species of monomer. A copolymer obtained from two monomer species is sometimes called a bipolymer; a copolymer obtained from three monomer species is sometimes called a terpolymer; a copolymer obtained from four monomer species is sometimes called a quaterpolymer; etc. A copolymer can be characterized based on the arrangement of branches in the structure, including, e.g., as a linear copolymer or a branch copolymer. A copolymer can also be characterized based on how the monomer units are arranged, including, e.g., as an alternating copolymer, a periodic copolymer, a statistical copolymer, a graft copolymer, or a block copolymer.

The term “copolymerization” refers to polymerization in which a copolymer is formed.

The term “coupling agent” means an additive that improves the interfacial adhesion between a polymeric matrix and a filler.

The term “dispersion” means a material comprising more than one phase where at least one of the phases includes finely divided phase domains (e.g., solid particles) distributed throughout a continuous phase domain (e.g., a liquid or melt-processed solid).

The term “filler” means a material that does not display viscoelastic characteristics during melt processing.

The term “functionalized liquid polymeric dispersion” means a liquid polymeric dispersion where at least one of the polymers of the liquid polymeric dispersion includes chemically reactive functional groups attached to a backbone of the polymer.

The term “highly filled” refers to a material, e.g., a polymeric concentrate, in which at least 80% of the material's total weight or at least 50% of the materials total volume consists of one or more fillers.

The term “let-down” or “let-down product” refers to the result of melt processing a highly filled compatibilized polymeric concentrate with a polymeric matrix, wherein the resulting polymeric composite has less than 50% by weight of filler.

The term “lightweight filler” means an organic or inorganic material with a specific gravity of less than 0.7 g/cm³ and does not possess viscoelastic characteristics under the conditions utilized to melt process a highly filled polymeric matrix.

The term “liquid carrier” refers to a solvent that is utilized to disperse a polymer to create a liquid polymeric dispersion.

The term “liquid polymeric dispersion” refers to a dispersion where the continuous phase domain flows freely and includes a polymer dispersed or dissolved in a liquid carrier.

The term “melt processing technique” means a technique for applying thermal and mechanical energy to reshape, blend, mix, or otherwise reform a polymer or composition, such as compounding, extrusion, injection molding, blow molding, rotomolding, or batch mixing.

The term “mixing” or “blending” means to combine or put together to form one single substance, mass, phase, or more homogenous state. This may include, but is not limited to, all physical blending methods, extrusion techniques, or solution methods.

The term “monomer” refers to a molecule that can undergo polymerization to contribute structural units to the essential structure of a polymer.

The terms “polymer” and “polymeric” refer a molecule of high relative molecular mass, the structure of which essentially contains multiple repetitions of units derived, actually or conceptually, from molecules of low relative molecular mass. The term “polymer” can refer to a “copolymer.”

The term “polymeric concentrate” or “masterbatch” refers to a concentrated mixture of an additive or filler in a liquid carrier, made of one or more polymers, often formed into a non-friable pellet or agglomerate.

The term “polymeric matrix” refers to a polymeric continuous phase, e.g., a melt processable thermoplastic, in a composite or composition.

The term “polymerization” refers to the process of converting monomers into a polymer.

The term “viscoelastic characteristics” means characteristics of a material that exhibits both viscous and elastic properties when subjected to deformation.

The recitation of numerical ranges using endpoints includes all numbers subsumed within that range (e.g., 1 to 5 includes 1, 1.5, 3, 3.95, 4.2, 5, etc.).

Highly filled compatibilized polymeric concentrates of the present disclosure comprise, e.g., using one or more melt processing techniques, a functionalized liquid polymeric dispersion, including a liquid carrier and one or more polymers, and one or more fillers. In some embodiments, other materials, e.g., additional polymers or additives, can also be included in a highly filled compatibilized polymeric concentrate.

A functionalized liquid polymeric dispersion can include various liquid carriers. Non-limiting examples of liquid carriers include: organic solvents or other hydrocarbon based oil, fluorinated oligomers, silicone based oils, or a mixture thereof. In some embodiments, the liquid carrier is water-based.

A functionalized liquid polymeric dispersion may include one or more polymers that can be delivered in liquid dispersion form. Non-limiting examples of polymers that can be used include: high density polyethylene (HDPE), maleated-low density polyethylene (LDPE), linear low density polyethylene (LLDPE), functional polyolefin copolymers including polyolefin based ionomers, polypropylene (PP), polyolefin copolymers (e.g., ethylene-butene, ethylene-octene, ethylene vinyl alcohol), polystyrene, polystyrene copolymers (e.g., high impact polystyrene, acrylonitrile butadiene styrene copolymer), polyacrylates, polymethacrylates, polyesters, polyvinylchloride (PVC), fluoropolymers, polyamides, polyether imides, polyphenylene sulfides, polysulfones, polyacetals, polycarbonates, polyphenylene oxides, polyurethanes, thermoplastic elastomers (e.g., SIS, SEB S, SBS), or combinations thereof. In some embodiments, polyolefins are well suited to serve as polymeric matrices for functionalized liquid polymeric dispersions.

At least a portion of the one or more polymers used in a liquid polymeric dispersion can be functionalized to produce a functionalized liquid polymeric dispersion.

Polymers can be functionalized by using a reactive polymer or monomer, copolymerizing the polymers with reactive moieties, or using reactive extrusion processes with reactive moieties. Non-limiting examples of reactive moieties include carboxylic acids, alcohols, amines, aldehydes, ketones, alkoxy silanes, isocyanates, amides, imides, acetals, ketals, and others. A non-limiting example of a functionalized liquid polymeric dispersion includes the polyolefin dispersions sold under the HYPOD brand name by Dow Chemical, specifically HYPOD 8503, which is a carboxylic acid functionalized polyolefin.

A functionalized liquid polymeric dispersion can be entirely or partially functionalized. In some embodiments, the functionalized liquid polymeric dispersion can optionally include a non-functionalized liquid polymeric dispersion. Non-limiting examples of such liquid polymeric dispersions include the polyolefin dispersions sold under HYPODTM by Dow Chemical or those sold under MichemTM or HydrosizeTM by Michelman; the waterborne sulfopolyester dispersions sold under Eastman AQTM by Eastman Chemical; or a salt of hexane-1,6-diamine and adipic acid (AH Salt), diluted with water to form a waterborne polymeric dispersion, sold by Ascend Performance.

A functionalized liquid polymeric dispersion may, for example, contain a solids content of at least about 5 wt %, at least about 10 wt %, at least about 20 wt %, at least about 30 wt %, at least about 40 wt %, at least about 50 wt %, or at least about 70 wt %. In one embodiment, the functionalized liquid polymeric dispersion comprises about 30-40 wt % solids. In another embodiment, the functionalized liquid polymeric dispersion comprises about 40-50 wt % solids. In yet another embodiment, the functionalized liquid polymeric dispersion comprises about 50 wt % solids.

In some embodiments, the functionalized liquid polymeric dispersion is a waterborne dispersion. In other embodiments, the functionalized liquid polymeric dispersion is a waterborne polyolefin dispersion. In some embodiments, the functionalized polymer is dispersed in a liquid solvent or oil. In other embodiments, the functionalized liquid polymeric dispersion is water-based. In another embodiment, the functionalized liquid polymeric dispersion contains a water-in-oil emulsion or an oil-in-water emulsion. In yet another embodiment, the functionalized liquid polymeric dispersion can be made by polymerizing a polymeric precursor (e.g., a salt of hexane-1,6-diamine and adipic acid) in a liquid carrier.

A variety of fillers can be used with a functionalized liquid polymeric dispersion to produce (e.g., by using melt processing techniques) a highly filled compatibilized polymeric concentrate. In view of this disclosure, one or more fillers can be selected to improve mechanical and thermal properties for desired applications, including, e.g., reducing the coefficient of thermal expansion of a let-down product. Non-limiting examples of fillers include mineral and organic fillers including carbonates, silicates, talc, mica, wollastonite, clay, silica, alumina, carbon fiber, carbon black, carbon nanotubes, graphite, graphene, volcanic ash, expanded volcanic ash, perlite, glass fiber, solid glass microspheres, hollow glass microspheres, cenospheres, ceramics, and conventional cellulosic materials including: wood flour, wood fibers, sawdust, wood shavings, newsprint, paper, flax, hemp, wheat straw, rice hulls, kenaf, jute, sisal, peanut shells, soy hulls, or any cellulose containing material.

The one or more fillers used to produce highly filled compatibilized polymeric concentrates can include one or more lightweight fillers. Non-limiting examples of lightweight fillers include hollow glass microspheres, cenospheres, perlite, and expanded volcanic ash.

Fillers can amount to at least 80 wt %, at least 85 wt %, at least 88 wt %, at least 90 wt %, at least 92 wt %, at least 95 wt %, or at least 98 wt % of a highly filled compatibilized polymeric concentrate. Fillers can amount to at least 50 volume %, at least 55 volume %, at least 60 volume %, at least 65 volume %, at least 70 volume %, at least 75 volume %, at least 80 volume %, at least 85 volume %, at least 90 volume %, at least 92 volume %, at least 95 volume %, or at least 98 volume % of a highly filled compatibilized polymeric concentrate.

In addition to the one or more polymers provided by a functionalized liquid polymeric dispersion, a variety of additional polymers can be used to produce a highly filled compatibilized polymeric concentrate, including those described previously.

A variety of additives can also be used to produce highly filled compatibilized polymeric concentrates. Non-limiting examples of additives include antioxidants, light stabilizers, fibers, blowing agents, foaming additives, antiblocking agents, heat stabilizers, impact modifiers, biocides, antimicrobial additives, compatibilizers, plasticizers, tackifiers, polymeric processing aids, lubricants, coupling agents, flame retardants, oxygen scavengers, and colorants. Additives may be used in the form of a powder, pellets, granules, or in any other extrudable form. The amount and type of additives used may vary depending upon the polymeric matrix and the desired physical properties of the finished composite.

Additives that are well suited for melt processing with functionalized liquid polymeric dispersions include coupling agents. Coupling agents can assist in the interfacial adhesion or other attraction between the polymeric matrix and fillers or other additives. Non-limiting examples of coupling agents include silanes, zirconates, titanates, and functionalized polymers, such as maleic anhydride grafted polymers. Non-limiting examples of maleic anhydride grafted polymers include those sold under the trademarks Polybond™ (Addivant), Extinity™ (NWP), Integrate™ (Lyondell Basell), and Fusabond™ (DuPont). Typical loading levels of coupling agents are approximately 0.1 to 5 wt % of the highly filled compatibilized polymeric concentrates.

In some embodiments, polymeric processing aids can be used as additives to reduce the viscosity and improve dispersion of highly filled compatibilized polymeric concentrates. Non-limiting examples of polymeric processing aids include polyolefin polymers and copolymers with low melting temperatures, such that they are in the melt state during melt processing. In other embodiments, polymeric processing aids include polyethylene-co-hexene, polyethylene-co-octene copolymers (commercially marketed as Engage™ by Dow Chemical Co), polypropylene elastomers and plastomers (Vistamaxx™ by Exxon Mobil Co.), and ethylene-co-vinyl acetate copolymers (Elvax™ commercially manufactured by Dow Chemical). In some other embodiments, polymeric processing aids include low molecular weight, low modulus polypropylene L-Modu™ S600 and S901 (commercially manufactured by Idemistu Kosan Co.).

A variety of different techniques, e.g., melt processing techniques, can be used to produce highly filled compatibilized polymeric concentrates. Highly filled compatibilized polymeric concentrates, including any additional polymers and/or additives, can be prepared by blending one or more fillers and a functionalized liquid polymeric dispersion to create a blended dispersion then melt processing the blended dispersion. Depending on the type and nature of the polymeric matrix, this can be done using a variety of blending processes. The filler(s) and functionalized liquid polymeric dispersion can be combined by, e.g., a compounding mill, a Banbury mixer, pellet mill, or a mixing extruder. In some embodiments, a vented twin screw extruder is utilized. The materials may be injected or supplied into the extruder at various insertion points such as the throat or at downstream ports in the extruder. The materials may be used in the form of, for example, a powder, pellets, or a granular product.

In some embodiments, a melt processing system is used to produce highly filled compatibilized polymeric concentrates. Such melt processing systems can comprise a melt processing device and a composition having one or more fillers and a functionalized liquid polymeric dispersion. Such melt processing devices can have one or more mixing elements and one or more heating elements. For example, a melt processing device can be a co-rotating twin screw extruder with segmented screws having mixing and conveying elements incorporated into the screw design as to optimize mixing of the filler(s) with the functionalized liquid polymeric dispersion. The barrels of the twin screw can be temperature controlled (heated and/or cooled) in a segmented fashion as well. Alternatively, another non-limiting example of a melt processing device is a pellet mill. In this instance, the functionalized liquid polymeric dispersion can be either premixed or sprayed onto the filler(s) in the preconditioning conveying screw auger, which acts as a mixing element. The material is then forced through a die under pressure and the shear results in heating of the highly filled compatibilized polymeric concentrate. In this instance, the die is the heating element of melt processing device. The one or more fillers are at least partially wetted by the one or more polymers of the functionalized liquid polymeric dispersion. The composition is in fluid contact with the mixing elements and the heating elements. In other embodiments, a melt processing system can additionally comprise additional polymers.

The blending operation is most conveniently carried out at a temperature above the melting point or softening point of the one or more polymers of the functionalized liquid polymeric dispersion. The minimum temperature is typically above the temperature required to devolatilize at least some of the liquid carrier in the functionalized liquid polymeric dispersion. For example, if the liquid carrier is water, the temperature should be greater than 100° C. during melt processing. The resulting melt processed highly filled compatibilized polymeric concentrate can be either extruded directly into the form of the final product, pelletized, or fed into a secondary operation (e.g., pellet mill or densifier) to be pelletized directly into pellet, agglomerate, or granulate form. The devolatilized liquid carrier can be vented or pulled away (e.g., using a vacuum) from the melt processing unit. The densified pellet, agglomerate or granulate has enough integrity such that it can be readily used in a subsequent compounding, extrusion, or molding step (viz., without breaking up into a fine particulate during transport, conveying, or feeding).

Melt-processing of the filler and functionalized liquid polymeric dispersion are typically performed at a temperature between 80 and 300° C., although other optimum operating temperatures are selected depending upon the liquid carrier boiling point(s) and the melting point, melt viscosity, and thermal stability of the polymer(s).

A highly filled compatibilized polymeric concentrate can be let-down to provide (e.g., using melt processing techniques) a variety of different compositions. In one embodiment, the highly filled compatibilized polymeric concentrate is melt processed with a polymeric matrix using conventional melt processing techniques known in the art. Nonlimiting examples of melt processing techniques include melt compounding, twin screw extrusion, thermokinetic mixing, banbury mixing, co-kneader mixing, farrel continuous mixing, injection molding, and extrusion. In one embodiment, the resulting composition contains less than 50 wt % of filler. In another embodiment, the resulting composition contains less than 40 wt % of filler. In yet another embodiment, the resulting composition contains less than 30 wt % of filler.

Highly filled compatibilized polymeric concentrates have broad utility in the automotive, building and construction, consumer and appliance industries. Non-limiting examples of potential uses include automotive components, decking, fencing, railing, roofing, siding, containers, and appliance housing. Highly filled compatibilized polymeric concentrates can provide significant value to plastic compounders and converters, and may be easier to handle, more cost effective, and more easily dispersed.

In the following examples, all parts and percentages are by weight unless otherwise indicated.

### EXAMPLES

TABLE 1
MATERIALS

| Material | Supplier |
|---|---|
| LPD | Liquid Polymeric Dispersion, HYPOD 1001, waterborne PE |
| | copolymer, 40-44 wt % solids, commercially available from |
| | Dow Chemical (Midland, MI) |
| FLPD | Functionalized Liquid Polymeric Dispersion, HYPOD 8503, |
| | waterborne PE copolymer, 40-44 wt % solids, commercially |
| | available from Dow Chemical (Midland, MI) |
| CA | Linxidan 4435, maleated polypropylene, commercially |
| | available from Saco Polymers (Sheboygan, WI) |
| PPA | Polymeric processing aid, low molecular weight |
| | polypropylene, L-Modu S600, commercially available from |
| | Idemistu Kosan Co. (Tokyo, Japan) |
| PP | Ineos H38G-00, 38 MFI polypropylene flake resin, |
| | commercially available from Bamberger Polymers (Jericho, |
| | NY) |
| Cellulose | BCTMP pulp fiber, commercially available from West Fraser |
| | Inc., Quesnel, BC. |

TABLE 2
EXPERIMENTAL CONCENTRATE FORMULATIONS

| | | | | | Weight % | Volume % |
|---|---|---|---|---|---|---|
| Example | LPD | FLPD1 | Cellulose | PPA | Filler | Filler |
| MB1 | 30 | — | 70 | — | 85.0 | 87 |
| MB2 | — | 30 | 70 | — | 85.0 | 87 |
| MB3 | — | 20 | 75 | 5 | 85.0 | 87 |
| MB4 | — | 20 | 70 | 10 | 85.0 | 87 |

TABLE 3
EXPERIMENTAL COMPOUND FORMULATIONS

| Example | PP | MB1 | MB2 | MB3 | MB4 | CA |
|---|---|---|---|---|---|---|
| CE1 | 64.5 | 23.5 | — | — | — | 2 |
| CE2 | 63 | 35 | — | — | — | 2 |
| 1 | 64.5 | — | 23.5 | — | — | 2 |
| 2 | 63 | — | 35 | — | — | 2 |
| 3 | 63 | — | — | 35 | — | 2 |
| 4 | 63 | — | — | — | 35 | 2 |

### Sample Preparation

For MB1-MB4, the filler and liquid polymeric dispersions were blended in a plastic bag, processed through an open faced (no die attached) 27 mm twin screw extruder (52:1 L:D, commercially available from Entek Extruders, Lebanon, Oreg.), and directly pelletized in a 5″ electric pellet mill (commercially available from Pellet Masters, Chippewa Falls, Wis.). Processing temperatures were as follows in zones 1-13: 50, 70, 90, 100, 100, 100, 100, 100, 100, 100, 100, 100, 100° C., respectively. The masterbatches (“MBs”) were then dried for 24 hours at 100° C. The MBs were subsequently let-down into a thermoplastic matrix using the following procedure. The PP, CA, and MBs were dry blended in a plastic bag and gravimetrically fed into a 27 mm twin screw extruder (52:1 L:D, commercially available from Entek Extruders, Lebanon, Oreg.). The compounding was performed using the following temperature profile in zones 1-13: 38, 177, 204, 204, 204, 204, 204, 204, 204, 204, 204, 204, 204° C., respectively. The compounds were extruded into strands and pelletized into pellets approximately 1-2 mm in length.

The resulting compounds were injection molded into test specimens and characterized following the ASTM D790 Standard and the ASTM D638 Standard. Specific gravity was determined using the Archimedes Method. Unnotched impact testing was performed following the ASTM D256 Standard. Moisture absorption was tested by submersing the test specimens in water for 96 hours and measuring mass uptake. The results of each test are given in Table 4.

TABLE 4
EXPERIMENTAL COMPOUND RESULTS

| | Flexural | Flexural | Specific | 96 Hour | Izod Impact |
|---|---|---|---|---|---|
| | Modulus | Strength | Gravity | Moisture | Unnotched |
| Example | (kpsi) | (kpsi) | (g/cm³) | Absorption | (ft-lbs/in) |
| CE1 | 271 | 6.2 | 0.99 | 0.29 | 3.3 |
| CE2 | 394 | 9.5 | 1.01 | 0.62 | 3.5 |
| 1 | 280 | 7.1 | 0.99 | 0.15 | 4.4 |
| 2 | 412 | 9.8 | 1.01 | 0.39 | 4.1 |
| 3 | 434 | 10.4 | 1.01 | 0.30 | 4.3 |
| 4 | 405 | 9.3 | 1.01 | 0.32 | 5.5 |

Comparative Examples CE1-CE2 demonstrate properties of compounds produced from highly filled compatibilized polymeric concentrates with non-functionalized liquid polymeric dispersions. Examples 1-4 demonstrate the mechanical properties of compounds produced from highly filled compatibilized polymeric concentrates of the present disclosure.

Having thus described particular embodiments, those of skill in the art will readily appreciate that the teachings found herein may be applied to yet other embodiments within the scope of the claims hereto attached.

1-16. (canceled)

17. A composition in a melt processing device, the composition comprising:
a highly filled compatibilized polymeric concentrate produced by melt processing a functionalized liquid polymeric dispersion and one or more fillers;
wherein the functionalized liquid polymeric dispersion comprises one or more polymers and a liquid carrier;
wherein the one or more fillers are at least partially contacting the one or more polymers and the liquid carrier of the functionalized liquid polymeric dispersion;
wherein at least a portion of the one or more polymers are functionalized;
wherein the one or more polymers are in a melt state; and
wherein the one or more fillers amount to at least 80 weight % or 50 volume % of the highly filled compatibilized polymeric concentrate.

18. The composition of claim 17, wherein the one or more fillers amount to at least 85 weight % or 60 volume % of the highly filled compatibilized polymeric concentrate.

19. The composition of claim 17, wherein the one or more fillers amount to at least 90 weight % or 70 volume % of the highly filled compatibilized polymeric concentrate.

20. The composition of claim 17, wherein the one or more fillers amount to at least 95 weight % or 80 volume % of the highly filled compatibilized polymeric concentrate.

21. The composition of claim 17, wherein the one or more fillers amount to at least 98 weight % or 90 volume % of the highly filled compatibilized polymeric concentrate.

22. The composition of claim 17, further comprising one or more additives.

23. A highly filled compatibilized polymeric concentrate comprising:
a functionalized liquid polymeric dispersion having one or more polymers and a liquid carrier; and
one or more fillers;
wherein at least a portion of the one or more polymers are functionalized;
wherein the one or more fillers amount to at least 80 weight % or 50 volume % of the highly filled compatibilized polymeric concentrate.

24. The highly filled compatibilized polymeric concentrate of claim 23, wherein the one or more fillers amount to at least 85 weight % or 60 volume % of the highly filled compatibilized polymeric concentrate.

25. The highly filled compatibilized polymeric concentrate of claim 23, wherein the one or more fillers amount to at least 90 weight % or 70 volume % of the highly filled compatibilized polymeric concentrate.

26. The highly filled compatibilized polymeric concentrate of claim 23, wherein the one or more fillers amount to at least 95 weight % or 80 volume % of the highly filled compatibilized polymeric concentrate.

27. The highly filled compatibilized polymeric concentrate of claim 23, wherein the one or more fillers amount to at least 98 weight % or 90 volume % of the highly filled compatibilized polymeric concentrate.

28. The highly filled compatibilized polymeric concentrate of claim 23, further comprising one or more additives.

29. A method for producing a highly filled compatibilized polymeric concentrate comprising:
blending one or more fillers and a functionalized liquid polymeric dispersion to make a blended dispersion; and
melt processing the blended dispersion to produce a highly filled compatibilized polymeric concentrate;
wherein the functionalized liquid polymeric dispersion has one or more polymers and a liquid carrier;
wherein at least a portion of the one or more polymers are functionalized; and
wherein the one or more fillers amount to at least 80 weight % or 50 volume % of the highly filled compatibilized polymeric concentrate.

30. The method of claim 29, wherein the melt processing occurs at a temperature above a boiling temperature of the liquid carrier.

31. The method of claim 29, wherein the highly filled compatibilized polymeric concentrate includes one or more additives.

32. The method of claim 31, wherein the one or more additives include a polymeric processing aid which can be in a melt state during melt processing around the boiling temperature of the liquid carrier.

33. The method of claim 29, wherein the one or more fillers amount to at least 85 weight % or 60 volume % of the highly filled compatibilized polymeric concentrate.

34. The method of claim 29, wherein the one or more fillers amount to at least 90 weight % or 70 volume % of the highly filled compatibilized polymeric concentrate.

35. The method of claim 29, wherein the one or more fillers amount to at least 95 weight % or 80 volume % of the highly filled compatibilized polymeric concentrate.

36. The method of claim 29, wherein the one or more fillers amount to at least 98 weight % or 90 volume % of the highly filled compatibilized polymeric concentrate.

37. A method of producing a let-down article comprising:
blending one or more fillers and a functionalized liquid polymeric dispersion together to make a blended dispersion;
melt processing the blended dispersion to make a highly filled compatibilized polymeric concentrate; and
melt processing the highly filled compatibilized polymeric concentrate with a polymeric matrix to provide a let-down product;
wherein the functionalized liquid polymeric dispersion has one or more polymers and a liquid carrier; and
wherein at least a portion of the one or more polymers are functionalized.
